(19) United States
(12) Patent Application Publication
(10) Pub. No.: US 2013/0235865 A1
(43) Pub. Date: Sep. 12, 2013

(54) APPARATUS AND METHOD FOR TRANSMITTING DATA IN BROADCASTING SYSTEM

(71) Applicant: ELECTRONICS AND TELECOMMUNICATIONS RESEARCH INSTITUTE, (US)

(72) Inventors: Ho Min EUM, Daejeon-si (KR); Heung Mook KIM, Daejeon-si (KR)

(73) Assignee: ELECTRONICS AND TELECOMMUNICATIONS RESEARCH INSTITUTE, Daejeon-si (KR)

(21) Appl. No.: 13/654,035

(22) Filed: Oct. 17, 2012

(30) Foreign Application Priority Data
Mar. 9, 2012 (KR) 10-2012-0024238

(51) Int. Cl. H04W 56/00; H04J 3/06

(52) U.S. Cl. 370/350

(57) ABSTRACT

An apparatus for transmitting data in a broadcasting system is provided. The apparatus comprises a basic broadcasting data encoder configured to encode basic broadcasting data streams to generate basic broadcasting signals; a synchronization unit configured to acquire synchronization information for synchronization between the basic broadcasting data streams and at least one additional data packet; an additional data multiplexing unit configured to input the synchronization information to each of the additional data packets and multiplex the additional data packets to which the synchronization information is input to generate additional data streams; an additional data encoder configured to encode the additional data streams to generate additional signals; an adding unit configured to generate mixed signals based on the basic broadcasting signals and the additional signals; a modulating unit configured to modulate the mixed signals to generate transmission signals; and a transmitting unit transmitting the transmission signals.

### CROSS-REFERENCE TO RELATED APPLICATIONS

This application claims the benefit of priority of Korean Patent Application No. 10-2012-0024238 filed on Mar. 9, 2012, all of which are incorporated by reference in their entirety herein.

### BACKGROUND OF THE INVENTION

1. Field of the Invention

The present invention relates to an apparatus and a method for transmitting data in a broadcasting system, and more particularly, to an apparatus and a method for synchronizing and transmitting basic broadcasting data packets and additional data packets.

2. Related Art

Communication technologies have been developed by being divided into a data service centered wired transmission technology and an audio service centered wireless transmission technology. Recently, with the development of a high-speed wireless transmission technology and the growth of a wired network infrastructure, wired/wireless integrated technologies capable of receiving data services while securing mobility have been continuously developed. The wired/wireless integrated technologies can provide services to users without being limited to an area and further diversify types of services.

Meanwhile, the broadcasting technologies have been rapidly changed from the existing analog type into a digital type. Due to the change of the broadcasting technologies, more services, such as the existing real-time broadcasting, two-way broadcasting, additional service provision, and the like, are provided to users. The broadcasting system forms a core of information infrastructure by being coupled with communication systems, such as the wired and wireless Internet.

Generally, the broadcasting system is present in a type in which various systems developed to provide various services are mixed. In the broadcasting system, a data transmission rate is determined according to standards of corresponding fields. For example, a data transmission rate of an advanced terrestrial systems committee (ATSC) standard is 19.39 Mbps in a 6 MHz band and a data transmission rate of a digital video broadcasting-terrestrial (DVB-T) standard is in a range between 4.354 Mbps and 27.710 Mbps in a 7 MHz band. In addition, a standard transmission data transmission rate of a terrestrial-digital multimedia broadcasting (T-DMB) is 1.125 Mbps in a 1.536 MHz band.

The data transmission rate, which is a factor of determining image quality of a broadcasting screen, may degrade image quality of the existing broadcasting screen at the time of transmitting additional data under the situation in which the data transmission rate is limited. An example of a method for transmitting a plurality of broadcasting contents under the situation in which the data transmission rate is limited may include a multi mode service (MMS). According to the method, the plurality of broadcasting contents each share the transmission rate of 19.39 Mbps. Therefore, the method lowers the transmission rate of the basic broadcasting data so as to transmit new additional data and therefore, may degrade the image quality of the existing broadcasting screen. As a result, a need exists for a method for transmitting data capable of transmitting additional data without affecting the basic broadcasting data.

### SUMMARY OF THE INVENTION

The present invention provides an apparatus and a method for transmitting data in a broadcasting system.

The present invention also provides an apparatus and a method for adding and transmitting additional data streams to basic broadcasting data streams in a digital TeleVision (DTV) broadcasting system.

The present invention also provides an apparatus and a method for synchronizing basic broadcasting data packets and additional data packets.

In an aspect, an apparatus for transmitting data in a broadcasting system is provided. The apparatus includes a basic broadcasting data encoder configured to encode basic broadcasting data streams to generate basic broadcasting signals; a synchronization unit configured to acquire synchronization information for synchronization between the basic broadcasting data streams and at least one additional data packet; an additional data multiplexing unit configured to input the synchronization information to each of the additional data packets and multiplex the additional data packets to which the synchronization information is input to generate additional data streams; an additional data encoder configured to encode the additional data streams to generate additional signals; an adding unit configured to generate mixed signals based on the basic broadcasting signals and the additional signals; a modulating unit configured to modulate the mixed signals to generate transmission signals; and a transmitting unit transmitting the transmission signals.

In another aspect, a synchronization apparatus for synchronization between basic broadcasting data streams and additional data packets in a broadcasting system is provided. The apparatus includes a synchronization information extractor configured to extract packet Identifiers (PIDs) and program clock references (PCRs) from the basic broadcasting data streams, the PIDs identifying elementary streams of basic broadcasting data streams, the PCRs being a criterion for synchronization between the elementary streams; a synchronization information assigner configured to assign the PIDs and the PCRs to each of the additional data packets; and a time calculator configured to calculate playing start time of the additional data packets, based on the PCRs.

In another aspect, a method for transmitting data in a broadcasting system. The method includes encoding basic broadcasting data streams to generate basic broadcasting signals; acquiring synchronization information for synchronization between the basic broadcasting data streams and at least one additional data packet; inputting the synchronization information to each of the additional data packets; multiplexing the additional data packets to which the synchronization information is input to generate additional data streams; encoding the additional data streams to generate additional signals; adding the additional signals to the basic broadcasting signals to generate mixed signals; modulating the mixed signals to generate transmission signals; and transmitting the transmission signals.

In another aspect, an apparatus for receiving data in a broadcasting system is provided. The apparatus includes a receiving unit configured to receive received signals; a demodulating unit configured to demodulate the received signals to generate mixed signals; a basic broadcasting signal detecting unit configured to detect basic broadcasting signals from the mixed signals; a basic broadcasting signal decoder configured to demodulate the basic broadcasting signals to generate basic broadcasting data streams; a subtracting unit configured to subtract the basic broadcasting signals from the mixed signals to detect additional signals; an additional signal decoder configured to decode the additional signals to generate additional data streams; and an additional data demultiplexing unit configured to demultiplex the additional data streams to generate at least one additional data packet. Each of the additional data packets includes synchronization information for synchronization between the basic broadcasting data streams and each of the additional data packets.

In another aspect, a method for receiving data in a broadcasting system is provided. The method includes receiving received signals; demodulating the received signals to generate mixed signals; detecting basic broadcasting signals and additional signals from the mixed signals; decoding the basic broadcasting signals to generate basic broadcasting data streams; decoding the additional signals to generate additional data streams; and demultiplexing the additional data streams to generate at least one additional data packet. Each of the additional data packets includes synchronization information for synchronization between the basic broadcasting data streams and each of the additional data packets.

### BRIEF DESCRIPTION OF THE DRAWINGS

FIG. 1 is a block diagram showing a configuration of an apparatus for transmitting basic broadcasting data and additional data.

FIG. 2 is a block diagram showing a configuration of an apparatus for synchronizing and transmitting the basic broadcasting data and the additional data according to the exemplary embodiment of the present invention.

FIG. 3 is a block diagram showing a detailed configuration of a multiplexing unit of FIG. 2.

FIG. 4 is a flow chart showing a method for transmitting data in a broadcasting system according to the exemplary embodiment of the present invention.

FIG. 5 is a block diagram showing a configuration of an apparatus for receiving data in the broadcasting system according to the exemplary embodiment of the present invention.

FIG. 6 is a flow chart showing a method for receiving data in the broadcasting system according to the exemplary embodiment of the present invention.

### DESCRIPTION OF EXEMPLARY EMBODIMENTS

With the development of various services and contents, services of a new concept such as data broadcasting, a non-real time (NRT) service, a disaster alert service, and the like, have appeared. Therefore, a need exists for methods for supporting and transmitting the additional services. In the existing broadcasting system, in order to provide the additional services, a method for reducing a data transmission rate of basic broadcasting data and assigning additional data to the remaining data transmission rate has been used. That is, a method for reducing a bandwidth assigned to basic broadcasting data and assigning a part of the bandwidth to additional services has been used. A Digital TeleVision (DTV) broadcasting system of an advanced terrestrial systems committee (ATSC) standard assigns about 2 Mbps for new additional service such as data broadcasting, and the like, among 19.39 Mbps assigned for HD broadcasting and reassigns the existing HD broadcasting to the remaining 17.4 Mbps. The method can lower the data transmit rate of the existing services for transmission of new additional services and therefore, degrades a quality of the existing service.

In addition, as the technologies of transmitting the additional data while maintaining the data transmission rate of the ATSC standard, there is a method for adding and transmitting additional data with relatively very small values to basic broadcasting data in a symbol unit. According to the aforementioned methods, it is possible to increase the transmission rate of the broadcasting system by simultaneously transmitting the additional data such as video, audio, real time/non-real time data and the basic broadcasting data.

However, the method for adding and transmitting the additional data to the basic broadcasting data does not present the method for synchronizing the additional data with the basic broadcasting data and therefore, the exemplary embodiment of the present invention is to provide a method for synchronizing the basic broadcasting data with the additional data. That is, according to the exemplary embodiment of the present invention, when adding and transmitting the additional data to the basic broadcasting data while securing backward compatibility in the DTV broadcasting system of the existing ATSC standard, it is possible to synchronize the basic broadcasting data with the additional data by extracting information for synchronization from an MPEG-2 transport stream (TS) and reflecting the extracted information to the additional data.

Hereinafter, the contents of the exemplary embodiment of the present invention will be described in detail with reference to the accompanying drawings.

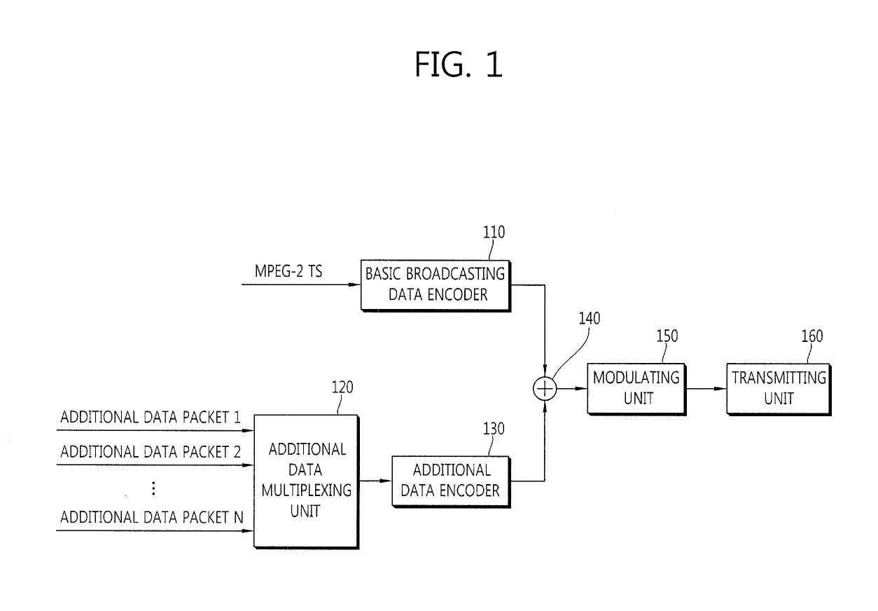

FIG. 1 is a block diagram showing a configuration of an apparatus for transmitting basic broadcasting data and additional data.

Referring to FIG. 1, basic broadcasting data packets multiplexed into an MPEG-2 transport stream (TS) are encoded by a basic broadcasting data encoder 110.

In addition, at least one additional data packet is multiplexed by an additional data multiplexing unit 120 and encoded by an additional data encoder 130.

The encoded basic broadcasting data packets and additional data packets are added in a symbol unit by an adder 140 and then, modulated by a modulating unit 150 and transmitted by a transmitting unit 160.

However, an apparatus for transmitting data in a broadcasting system as shown in FIG. 1 adds synchronization information without sharing the synchronization information between the basic broadcasting data packets and the additional data packets and therefore, it is difficult to accurately match the synchronization between the two data packets.

For example, when a part of the additional data packets is sign language broadcasting data packets for deaf people, the synchronization between the basic broadcasting and the signal language broadcasting may not correspond to each other.

Meanwhile, a plurality of programs may be present in the MPEG-2 TS. In this case, each of the elementary streams (ESs) such as video, audio, data, and the like, of the plurality of programs has packet identifiers (PIDs) that are unique identification numbers. For example, when a specific program number is 1 (program number=1) and a program map table packet identifier is 100 (PMT_PID=100), a video packet identifier may be assigned with 101 (Video_PID=101), an audio packet identifier may be assigned with 102 (Audio_PID=102), and a data packet identifier may be assigned with 103 (Data_PID=103). Here, the Data_PID may also mean a subtitle packet identifier. As another example, when a specific program number is 2 (program number=2) and the PMT_PID is 200, the Video_PID may be assigned with 201 and the Audio_PID may be assigned with 202 and 203.

In addition, in all the programs, a transport stream (TS) packet header includes program clock references (PCRs) that are reference values for synchronization between the ESs. Different programs may include different PCRs. A packetized elementary stream packet header (PES) is assigned with decoding time stamps (DTSs) that are time values in which each playing unit is to decoded based on the PCRs and presentation time stamps (PTSs) that are time values to be played. For example, when the PCRs of the transport stream packet header are 100 and the PTSs in any playing unit are 200, the decoder plays the playing unit when the PCRs are 200.

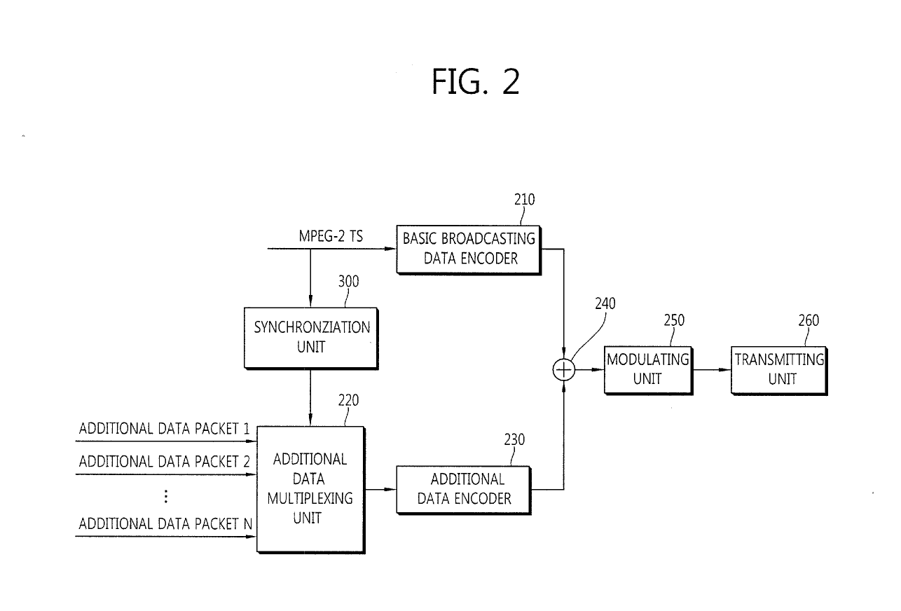

FIG. 2 is a block diagram showing a configuration of an apparatus for synchronizing and transmitting the basic broadcasting data and the additional data according to the exemplary embodiment of the present invention.

Referring to FIG. 2, the apparatus for transmitting data in the broadcasting system according to the exemplary embodiment of the present invention may include a basic broadcasting data encoder 210, an additional data multiplexing unit 220, an additional data encoder 230, an adding unit 240, a modulating unit 250, a transmitting unit 260, and a synchronizer 300.

The basic broadcasting data encoder 210 encodes basic broadcasting data streams to generate a basic broadcasting signal. The basic broadcasting data streams correspond to the case in which at least one basic broadcasting data packet is multiplexed, for example, the case in which at least one basic broadcasting data packet is multiplexed into the MPEG-2 TS type.

The additional data multiplexing unit 220 multiplexes at least one additional data packet to generate the additional data streams and the additional data encoder 230 encodes the additional data streams to generate additional signals.

The adding unit 240 generates mixed signals based on the basic broadcasting signals and the additional signals. That is, the adding unit 240 adds the additional signals to the basic broadcasting signals to generate the signals in which the basic broadcasting signals and the additional signals are mixed with each other. In order to spread-spectrum and pad the additional signals in a foil of noise that little affects the basic broadcasting signal, the adding unit 240 may include an additional data modulating unit that controls a band of the additional signals and an padding level control unit that controls a padding level of the additional signals. The additional data modulating unit modulates the band of the additional signals into the band of the basic broadcasting signals and the padding level control unit controls an average power of the additional signals. Therefore, the additional signals may be controlled so as to little affect the basic broadcasting signals.

The modulating unit 250 modulates the mixed signals to generate the transmission signals. That is, the modulating unit 250 modulates the signals in which the basic broadcasting signals and the additional signals are mixed with each other into a signal of a radio frequency (RF) band suitable for wireless transmission.

The transmitting unit 260 transmits the transmission signal. That is, the transmitting unit 260 transmits the signals modulated by the modulating unit 250.

Meanwhile, the synchronizing unit 300 acquires information for synchronization between the basic broadcasting data streams and at least one additional data packet. That is, the synchronizing unit 300 extracts the packet information from the basic broadcasting stream, and acquires the information for synchronization between the basic broadcasting data packets and the additional data packets based on the extracted packet information, and transmits the acquired synchronization information to the additional data multiplexing unit 220. The additional data multiplexing unit 220 inputs the received synchronization information to each of the additional data packets and generates time stamps required to decode and play the additional data packets and inputs the generated time stamps to a packet header.

For example, when a part of the additional data packets is video packets for sign language broadcasting corresponding to the basic broadcasting data packets, the synchronizing unit 300 acquires the information for synchronization between the basic broadcasting data packets and the video packets for the sign language broadcasting and transmits the acquired information to the additional data multiplexing unit 220. The additional data multiplexing unit 220 inputs the received information to the video packets for sign language broadcasting and generates the time stamps required for decoding and playing and inputs the generated time stamps to the packet header.

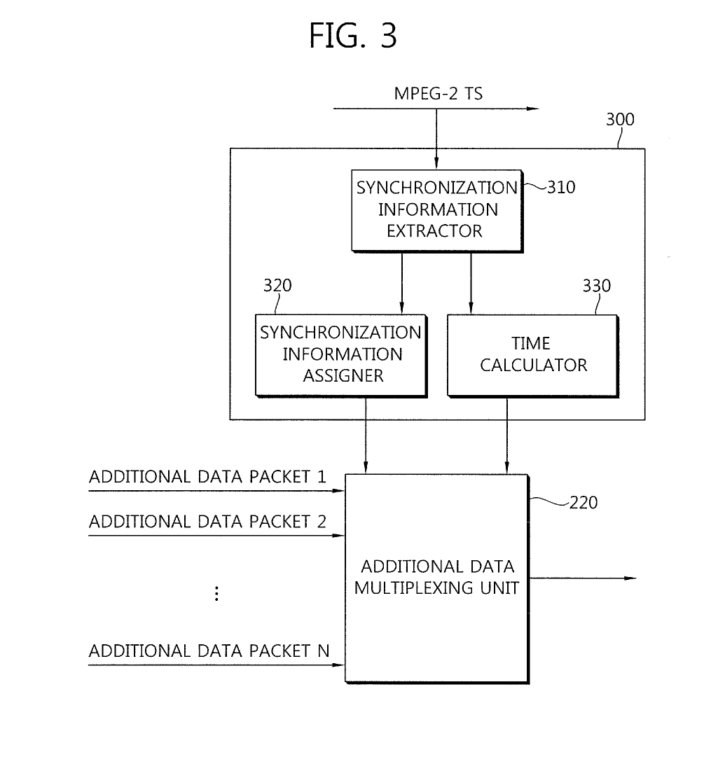

FIG. 3 is a block diagram showing a detailed configuration of the multiplexing unit of FIG. 2.

Referring to FIG. 3, the multiplexing unit 300 according to the exemplary embodiment of the present invention includes a synchronization information extractor 310, a synchronization information assigner 320, and a time calculator 330.

The synchronization information extractor 310 extracts the synchronization information from the basic broadcasting data stream. As the synchronization information for synchronization between the basic broadcasting data streams and the additional data packets, the PIDs and the PCRs may be used. As described above, the PIDs are unique identification numbers of the ESs and the PCRs are a criterion for synchronization between the ESs.

The synchronization information assigner 320 determines what synchronization information is assigned to the plurality of additional data packets, respectively, when the additional data packet to which the synchronization information extracted by the synchronization information extractor 310 is input is in plural. For example, the synchronization information assigner 320 assigns the PIDs and the PCRs to the plurality of additional data packets, respectively. For example, the synchronization information assigner 320 may assign ([PID 1, PCR 1]=[additional data 1, additional data 2]) PID 1 and PCR 1 to additional data packet 1 and additional data packet 2 according to editor' intention, when the extracted PIDs are PID 1, PID 2, . . . , PID N and the PCRs are PCR 1, PCR 2, . . . , PCR N and assign ([PID 2, PCR 2]=[additional data 3, additional data 4]) PID 2 and PCR 2 to additional data packet 3 and additional data packet 4. That is, the synchronization information assigner 320 forms the PIDs, the PCRs, and the additional data packets as a group.

The time calculator 330 calculates playing start time of the additional data packets based on the PCRs extracted by the synchronization information extractor 310. The plurality of additional data each require information regarding when the elementary streams are to be played, when the elementary streams to be played among the elementary streams of the plurality of programs are played. Therefore, the time calculator 330 calculates the playing start time of each of the additional data packets based on the PCRs extracted by the synchronization information extractor 310.

The additional data multiplexing unit 220 receives the synchronization information for synchronization between the basic broadcasting data streams and the additional data packets from the synchronization unit 300 and inputs the received synchronization information to each of the additional data packets and generates the time stamps required for decoding and playing of the additional data and inputs the generated time stamps to the packet header. For example, the additional data multiplexing unit 220 receives the PIDs and the PCRs from the synchronization information assigner 320 and receives the playing start time from the time calculator 330, thereby inputting the PID, PCR, and/or playing start time to each of the additional data packets. In addition, the additional data multiplexing unit 220 may generate the time stamps based on the PCRs and input the generated time stamps to the packet header.

Therefore, according to the exemplary embodiment of the present invention, each of the plurality of additional data packets that is synchronized with the basic data streams may be played together with the basic data at the time of the playing start time based on the PCRs when the elementary streams corresponding to the input PIDs are played.

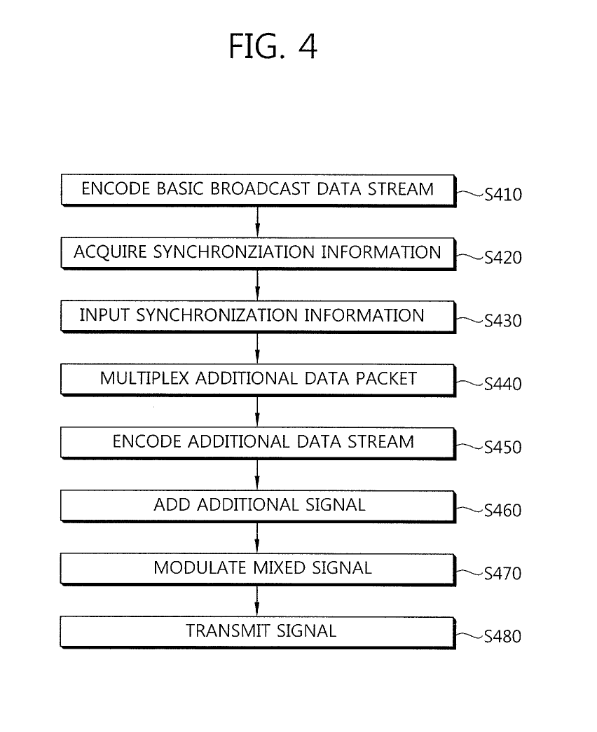

FIG. 4 is a flow chart schematically showing a method for transmitting data in a broadcasting system according to the exemplary embodiment of the present invention.

Referring to FIG. 4, a method for transmitting data in a broadcasting system according to an exemplary embodiment of the present invention includes encoding the basic broadcasting data streams (S410), acquiring the synchronization information (S420), inputting the synchronization information (S430), multiplexing the additional data packets (S440), encoding the additional data streams (S450), adding the additional signals (S460), and modulating the mixed signals (S470), and transmitting the signals (S480).

In the encoding of the basic broadcasting data streams (S410), the basic broadcasting data encoder encodes the basic broadcasting data streams to generate the basic broadcasting signals. As described above, the basic broadcasting data streams may be that at least one basic broadcasting data packet is multiplexed into the MPEG-2 transport stream.

In the acquiring of the synchronization information (S420), the synchronization unit acquires the information for synchronization between the basic broadcasting data streams and at least one additional data packet. As described above, the information for synchronization may include the PIDs, the PCRs, and/or the playing start time of the additional data packets, respectively. In detail, in the acquiring of the synchronization information (S420), the synchronization information extractor extracts the PIDs and the PCRs from the basic broadcasting data streams and the synchronization information assigner assigns the PIDs and the PCRs to the additional data packets, respectively. Further, the time calculator calculates the playing start time of the additional data packets, respectively, based on the PCRs.

In the inputting of the synchronization information (S430), the multiplexing unit inputs the synchronization information acquired by the synchronization unit to the additional data packets, respectively.

In the multiplexing of the additional data packets (S440), the multiplexing unit multiplexes the additional data packets to which the information for synchronization in the inputting of the synchronization information (S430) is input to generate the additional data streams and in the encoding of the additional data streams (S450), the additional data encoder encodes the additional data streams to generate the additional signals.

In the adding of the additional signals (S460), the adding unit adds the additional signals generated in the encoding of the additional data streams (S450) to the basic broadcasting signals generated in the encoding of the basic broadcasting data stream (S410) to generate the mixed signals. Meanwhile, as described above, the adding unit can also control the band and average power of the additional signals by spreading-spectrum and padding the additional signals in a form of noise that little affects the basic broadcasting signals.

In addition, in the modulating of the mixed signals (S470), the modulating unit modulates the signals formed by synchronizing the basic broadcasting signals and the additional signals in the adding of the additional signals (S460) to generate the transmission signals and in the transmitting of the signals (S480), the transmission signals are transmitted.

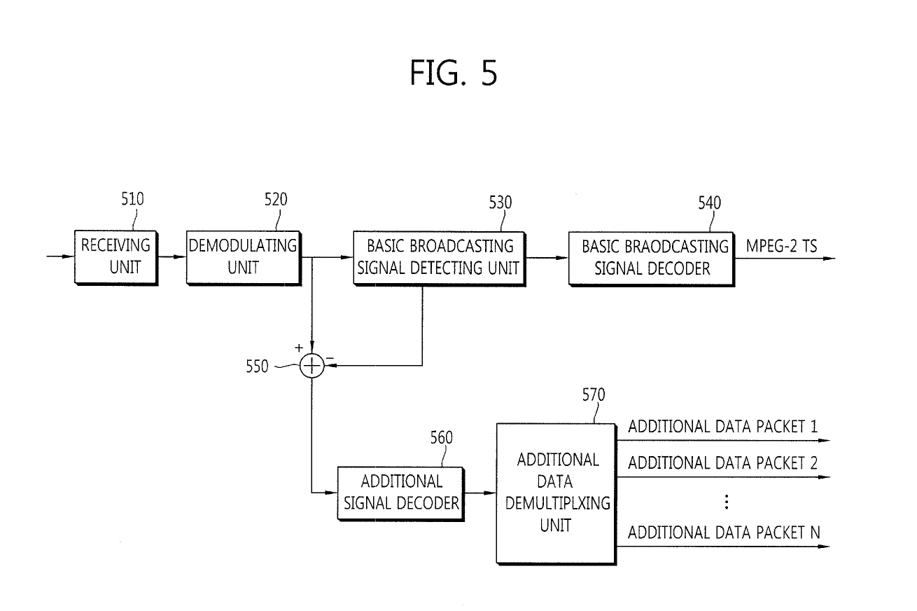

FIG. 5 is a block diagram showing a configuration of an apparatus for receiving data in a broadcasting system according to an exemplary embodiment of the present invention.

Referring to FIG. 5, the apparatus for receiving data in the broadcasting system according to the exemplary embodiment of the present invention includes a receiving unit 510, a demodulating unit 520, a basic broadcasting signal detecting unit 530, a basic broadcasting signal decoder 540, a subtracting unit 550, an additional signal decoder 560, and an additional data demultiplexing unit 570.

The receiving unit 510 receives the received signals and the demodulating unit 520 demodulates the received signals to generate the mixed signals. That is, the demodulating unit 520 demodulates the signals received through the receiving unit 510 into the signals in which the basic broadcasting signals and the additional signals are mixed with each other.

Meanwhile, at least one propagation path is present between the transmitting apparatus and the receiving apparatus and therefore, multi-path channel distortions may occur. Therefore, the demodulating unit 520 may also include a process and/or an apparatus for compensating the multi-path channel distortions of the received signals.

The basic broadcasting signal detecting unit 530 detects the basic broadcasting signals from the mixed signals and the basic broadcasting signal decoder 540 decodes the basic broadcasting signals to generate the basic broadcasting data streams. The basic broadcasting data streams may be that at least one basic broadcasting data packet is multiplexed, for example, that at least one basic broadcasting data packet is multiplexed into the MPEG-2 TS type

The subtracting unit 550 subtracts the basic broadcasting signals from the mixed signals to detect the additional signals. Meanwhile, in the exemplary embodiment of the present invention, the basic broadcasting signals and the additional signals may be detected by a method for detecting the basic broadcasting signals and subtracting the mixed signals from the basic broadcasting signals, but the basic broadcasting signals and the additional signals may also be detected by other methods, such as a method for using a signal determiner, a method for subtracting signals obtained by encoding the basic broadcasting data streams again from the mixed signals, and the like.

The additional signal decoder 560 decodes the additional signals to generate the additional data streams and the additional data demultiplexing unit 570 demultiplexes the additional data streams to generate at least one additional data packet.

Meanwhile, each of the additional data packets includes the synchronization information for synchronization between the basic broadcasting data streams and the additional data packets, respectively. For example, each of the additional data packets may include the packet Identifiers (PIDs) that are the identification numbers of the elementary streams of the basic broadcasting data streams, the PCRs that are a criterion for synchronization between the elementary streams, and/or the playing start time of the additional data packets calculated based on the PCR, respectively and may be played together with the basic data at the time of the playing start time based on the PCR when the elementary streams corresponding to the PID are played.

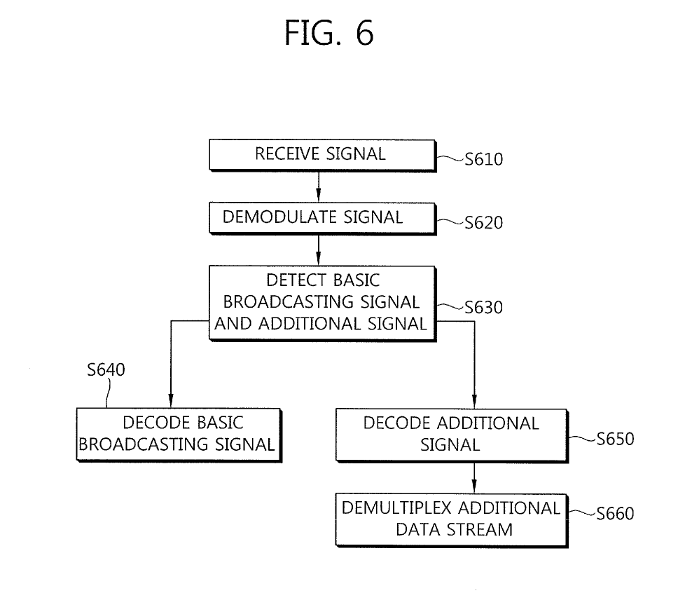

FIG. 6 is a flow chart showing a method for receiving data in a broadcasting system according to the exemplary embodiment of the present invention.

Referring to FIG. 6, the method for receiving data in the broadcasting system according to the exemplary embodiment of the present invention may include receiving the signals (S610), demodulating the signals (S620), detecting the basic broadcasting signals and the additional signals (S630), decoding the basic broadcasting signals (S640), decoding the additional signals (S650), and demultiplexing the additional data streams (S660).

In the receiving of the signals (S610), the receiving unit receives the received signals and in the demodulating of the signals (S620), the demodulating unit demodulates the received signals to generate the mixed signals. The demodulating of the signals (S620) may also include compensating for the multi-path channel distortions of the received signals.

In the detecting of in the basic broadcasting signals and the additional signals (S630), the basic broadcasting signals and the additional signals are detected in the mixed signals.

In the decoding of the basic broadcasting signals (S640), the basic broadcasting signal decoder decodes the basic broadcasting signals detected in the detecting of the basic broadcasting signals and the additional signals (S630) to generate the basic broadcasting data streams. As described above, the basic broadcasting data streams may be that at least one basic broadcasting data packet is multiplexed into the MPEG-2 transport stream.

In the decoding of the additional signals (S650), the additional broadcasting signal decoder decodes the additional signals detected in the detecting of the basic broadcasting signals and the additional signals (S630) to generate the additional data stream.

In the demultiplexing of the additional data streams (S660), the additional data demultiplexing unit demultiplexes the additional data streams to generate at least one additional data packet.

Meanwhile, each of the additional data packets includes the synchronization information for synchronization between the basic broadcasting data streams and the additional data packets, respectively. For example, each of the additional data packets may include the PID, the PCR, and/or the playing start time of the additional data packets, respectively.

According to the exemplary embodiments of the present invention, it is possible to synchronize and transmit the basic broadcasting data packets and the additional data packets.

According to the exemplary embodiments of the present invention, it is possible to add and transmit the additional data to the basic broadcasting data in the Digital TeleVison (DTV) broadcasting system of the advanced terrestrial systems committee (ATSC) standard.

The foregoing present invention is described with reference to a series of functional blocks. However, it will be apparent to those skilled in the art that the foregoing present invention is not limited by the foregoing embodiments and the accompanying drawings but by the claims, and various modifications and changes may be made without departing from the scope and spirit of the invention.

In the above-mentioned exemplary system, although the methods have described based on a flow chart as a series of steps or blocks, the present invention is not limited to a sequence of steps but any step may be generated in a different sequence or simultaneously from or with other steps as described above. Further, it may be appreciated by those skilled in the art that steps shown in a flow chart is non-exclusive and therefore, include other steps or deletes one or more steps of a flow chart without having an effect on the scope of the present invention.

The above-mentioned embodiments include examples of various aspects. Although all possible combinations showing various aspects are not described, it may be appreciated by those skilled in the art that other combinations may be made. Therefore, the present invention should be construed as including all other substitutions, alterations and modifications belong to the following claims.

What is claimed is:

1. An apparatus for transmitting data in a broadcasting system, the apparatus comprising:
a basic broadcasting data encoder configured to encode basic broadcasting data streams to generate basic broadcasting signals;
a synchronization unit configured to acquire synchronization information for synchronization between the basic broadcasting data streams and at least one additional data packet;
an additional data multiplexing unit configured to input the synchronization information to each of the additional data packets and multiplex the additional data packets to which the synchronization information is input to generate additional data streams;
an additional data encoder configured to encode the additional data streams to generate additional signals;
an adding unit configured to generate mixed signals based on the basic broadcasting signals and the additional signals;
a modulating unit configured to modulate the mixed signals to generate transmission signals; and
a transmitting unit transmitting the transmission signals.

2. The apparatus of claim 1, wherein the basic broadcasting data streams are that at least one basic broadcasting data packet is multiplexed into an MPEG-2 transport stream type.

3. The apparatus of claim 1, wherein the synchronization information comprises packet Identifiers (PIDs) and program clock references (PCRs), the PIDs identifying elementary streams of the basic broadcasting data streams, the PCRs being a criterion for synchronization between the elementary streams.

4. The apparatus of claim 3, wherein the synchronization information further comprises playing start time of each of the additional data packets, the playing start time being calculated based on the PCRs.

5. The apparatus of claim 1, wherein the synchronization unit comprises:
a synchronization information extractor configured to extract packet Identifiers (PIDs) and program clock references (PCRs) from the basic broadcasting data streams, the PIDs identifying elementary streams of the basic broadcasting data streams, the PCRs being a criterion for synchronization between the elementary streams;
a synchronization information assigner configured to assign the PIDs and the PCRs to each of the additional data packets; and
a time calculator configured to calculate playing start time of each of the additional data packets, based on the PCRs.

6. The apparatus of claim 1, wherein the adding unit is configured to add the additional signals to the basic broadcasting signals to generate the mixed signals.

7. The apparatus of claim 1, wherein the adding unit is configured to control a band and average power of the additional signals to generate transform signals and add the transform signals to the basic broadcasting signals to generate the mixed signals.

8. A synchronization apparatus for synchronization between basic broadcasting data streams and additional data packets in a broadcasting system, the apparatus comprising:
a synchronization information extractor configured to extract packet Identifiers (PIDs) and program clock references (PCRs) from the basic broadcasting data streams, the PIDs identifying elementary streams of basic broadcasting data streams, the PCRs being a criterion for synchronization between the elementary streams;
a synchronization information assigner configured to assign the PIDs and the PCRs to each of the additional data packets; and
a time calculator configured to calculate playing start time of the additional data packets, based on the PCRs.

9. A method for transmitting data in a broadcasting system, the method comprising:
encoding basic broadcasting data streams to generate basic broadcasting signals;
acquiring synchronization information for synchronization between the basic broadcasting data streams and at least one additional data packet;
inputting the synchronization information to each of the additional data packets;
multiplexing the additional data packets to which the synchronization information is input to generate additional data streams;
encoding the additional data streams to generate additional signals;
adding the additional signals to the basic broadcasting signals to generate mixed signals;
modulating the mixed signals to generate transmission signals; and
transmitting the transmission signals.

10. The method of claim 9, wherein the basic broadcasting data streams are that at least one basic broadcasting data packet is multiplexed into an MPEG-2 transport stream type.

11. The method of claim 9, wherein the synchronization information comprises packet Identifiers (PIDs) and program clock references (PCRs), the PIDs identifying elementary streams of the basic broadcasting data streams, the PCRs being a criterion for synchronization between the elementary streams.

12. The method of claim 11, wherein the synchronization information further comprises playing start time of each of the additional data packets, the playing start time being calculated based on the PCRs.

13. The method of claim 9, wherein the acquiring of the synchronization information comprises:
extracting packet Identifiers (PIDs) and program clock references (PCRs) from the basic broadcasting data streams, the PIDs identifying elementary streams of the basic broadcasting data streams, the PCRs being a criterion for synchronization between the elementary streams;
assigning the PIDs and the PCRs to each of the additional data packets; and
calculating playing start time of each of the additional data packets, based on the PCRs.

14. An apparatus for receiving data in a broadcasting system, the apparatus comprising:
a receiving unit configured to receive received signals;
a demodulating unit configured to demodulate the received signals to generate mixed signals;
a basic broadcasting signal detecting unit configured to detect basic broadcasting signals from the mixed signals;
a basic broadcasting signal decoder configured to demodulate the basic broadcasting signals to generate basic broadcasting data streams;
a subtracting unit configured to subtract the basic broadcasting signals from the mixed signals to detect additional signals;
an additional signal decoder configured to decode the additional signals to generate additional data streams; and
an additional data demultiplexing unit configured to demultiplex the additional data streams to generate at least one additional data packet,
wherein each of the additional data packets comprises synchronization information for synchronization between the basic broadcasting data streams and each of the additional data packets.

15. The apparatus of claim 14, wherein the basic broadcasting data streams are that at least one basic broadcasting data packet is multiplexed into an MPEG-2 transport stream type.

16. The apparatus of claim 14, wherein the synchronization information comprises packet Identifiers (PIDs) and program clock references (PCRs), the PIDs identifying elementary streams of the basic broadcasting data streams, the PCRs being a criterion for synchronization between the elementary streams.

17. The apparatus of claim 16, wherein the synchronization information further comprises playing start time of each of the additional data packets, the playing start time being calculated based on the PCRs.

18. A method for receiving data in a broadcasting system, the method comprising:
receiving received signals;
demodulating the received signals to generate mixed signals;
detecting basic broadcasting signals and additional signals from the mixed signals;
decoding the basic broadcasting signals to generate basic broadcasting data streams;
decoding the additional signals to generate additional data streams; and
demultiplexing the additional data streams to generate at least one additional data packet,
wherein each of the additional data packets comprises synchronization information for synchronization between the basic broadcasting data streams and each of the additional data packets.

19. The method of claim 18, wherein the synchronization information comprises packet Identifiers (PIDs) and program clock references (PCRs), the PIDs identifying elementary streams of the basic broadcasting data streams, the PCRs being a criterion for synchronization between the elementary streams.

20. The method of claim 19, wherein the synchronization information further comprises playing start time of each of the additional data packets, the playing start time being calculated based on the PCRs.
